(19) United States
(12) Patent Application Publication
(10) Pub. No.: US 2026/0193437 A1
(43) Pub. Date: Jul. 9, 2026

(54) WASTE PVB PROCESSING METHOD

(71) Applicant: TARKETT GDL, Lentzweiler (LU)

(72) Inventors: Guillaume Chatte, Wiltz (LU); Jean-Yves Clavier, Villeurbanne (FR)

(73) Assignee: TARKETT GDL, Lentzweiler (LU)

(21) Appl. No.: 19/135,208

(22) PCT Filed: Dec. 6, 2023
(86) PCT No.: PCT/EP2023/084508

§ 371 Date: Jun. 3, 2025

(30) Foreign Application Priority Data
Dec. 8, 2022 (LU) LU503158

(51) Int. Cl. C08J 11/06

(52) U.S. Cl. CPC C08J 11/06; C08J 2329/02

(57) ABSTRACT

A method of processing PVB, in particular waste PVB, comprises providing post-consumer or post-industrial PVB, e.g., in the form of flakes or granules, extracting plasticizer from the PVB with supercritical carbon dioxide, i.e., carbon dioxide at a temperature above its critical temperature of 31° C. and pressurized above its critical pressure of 7.3773 MPa (73.773 bar). The extraction may be carried out with supercritical CO2 at a pressure in the range from 80 to 500 bar, preferably from 100 to 450 bar, more preferably from 150 to 400 bar, and at a temperature in the range from 33° C. to 70° C., preferably from 35° C. to 60° C., and more preferably in the range from 38° C. to 45° C.

### BACKGROUND OF THE INVENTION

The invention generally relates to the processing of post-consumer or post-industrial PVB (polyvinyl butyral), herein also referred to as “waste PVB” for simplicity. More specifically, the invention relates to the separation of PVB resin from plasticizers. An aspect of the invention further relates to recycling PVB resin recovered from waste PVB in decorative surface coverings, such as, e.g., flooring, wallcoverings and/or ceiling coverings.

PVB is a random terpolymer comprised of vinyl butyral, vinyl alcohol (VA) and vinyl acetate (VAc) monomer moieties. Virgin PVB is obtained by the condensation reaction of polyvinyl alcohol, itself typically obtained through hydrolysis of polyvinyl acetate (resulting in the presence of a few residual VAc), and butyraldehyde. Recycled PVB is available in different grades and is significantly cheaper than virgin PVB. However, recycled PVB typically has a high plasticizer content that sometimes prevents it from being used as purchased in the production of decorative surface coverings.

PVB has interesting properties for various applications. PVB has outstanding optical transparency, the ability to bond to inorganic materials such as metal, glass and ceramics, a high toughness. PVB is widely used in interlayers of safety glass, e.g., for vehicles, buildings, and other applications. Other applications include thermoplastic processing, but, due to its vinyl alcohol units, PVB can also be employed in cross-linking compositions (e.g., in combination with epoxy resin or isocyanate).

PVB has also been considered as the primary or a secondary polymer resin in flooring applications. For instance, EP 0 950 688 A1 discloses a polyvinyl chloride (PVC) floor covering comprising PVB and magnesium hydroxide in addition to conventional additives.

EP 0 853 097 A1 relates to a thermoplastic blend, which can be processed to form resilient flooring, and which comprises PVB and a polymer which contains a polar moiety which is effective to form a hydrogen bond with the PVB. The polymer having the polar moiety may be selected from among polyethylene methacrylic acid, the partial metal salt of polyethylene methacrylic acid, polyethylene acrylic acid, polyethylene vinyl acetate, polyamide, polyamine, a thermoplastic urethane, polyvinyl alcohol, polyethylene carbon monoxide, and mixtures thereof.

EP 1 104 783 A1 relates to a floor or wall covering comprising a mixture of PVB resin and ethylene-vinyl acetate (EVA) copolymer, a glycol benzoate plasticizer, fillers, and additives.

EP 0 471 658 A2 discloses floorings and flooring compositions containing recycled plasticized PVB resin. The recycled PVB may contain up to 10% by weight of minute glass particles, due to the sourcing of the PVB from laminated safety glass.

EP 1 599 335 A1 uses post-consumer and/or post-industrial PVB (recovered or recycled PVB or PVB waste) as an ingredient of the backcoating, precoat and main backcoat compositions of floor coverings such as carpeting, pile carpets and carpet tiles. The document more specifically proposes mixtures of recycled PVB, plasticizer and filler; mixtures of recycled PVB, plasticizer, ethylene vinyl acetate (EVA) and filler; mixtures of recycled PVB, tackifier composition(s), EVA, and filler (and, optionally, a plasticizer); mixtures of recycled PVB, plasticizer, anionic surfactant, and filler; as well as extruded recycled PVB alone or in combination with fillers or other additives. The recycled PVB compositions are considered to have excellent chemical and physical properties, long term durability and compatibility with other floorings. The recycled PVB may comprise glass particles and other contaminants. The recycled PVB is processed to separate the PVB from glass and other components through shredding and density differences. As a rule, recycled PVB contains plasticizer (typically between about 30 to about 50 phr). EP 1 599 335 A1 specifies that the recycled PVB can contain plasticizers (and other contaminants) for the purposes disclosed therein.

WO 93/02141 A1 discloses a process for recycling PVB, wherein waste PVB is melt-blended with an incompatible polymer having a melt processing temperature less than the PVB decomposition temperature and an effective amount of anhydride-modified polymer that compatibilizes the resultant blend.

DE 4 202 948 A1 discloses floor coverings comprising 30-60% recycled PVB, 5-20% polyacrylate (PA) and 20-60% filler. Optional additives include pigments, UV-stabilizers, flame retardants, antistatic agents, or antibacterial agents. The document mentions a plasticizer content of 5-50% for the recycled PVB but it is clear from the document that low plasticizer content is not considered desirable. If the plasticizers introduced into the composition via the recycled PVB are not sufficient, further plasticizer(s), e.g., plasticizers compatible with both PVB and PA, can be added to the composition. The document also discusses the possibility of blending recycled PVB, containing plasticizer, with a sufficient amount of unplasticized virgin PVB and about the same amount of filler, and forming floor coverings with the composition thus obtained. It is mentioned that the floor coverings exhibit shortcomings in terms of residual indentation and stability in the presence of moisture.

U.S. Pat. No. 5,739,270 relates to a method and apparatus for continuously separating polymer from a plastic, and the resulting separated polymer. The plastic is made flowable into a stream through melting or solubilizing. A (super) critical fluid, such as supercritical carbon dioxide, is added to the plastic stream to promote mechanical or thermodynamic separation of the polymer from contaminants and other components of the plastic. The plastic is mixed with a cosolvent, which at least partially dissolves the polymer, and which is miscible in the fluid. The critical or supercritical fluid is then introduced into the plastic-cosolvent mixture.

U.S. Pat. No. 10,626,241 discloses a system and a method for cleaning and upgrading post-consumer and/or post-industrial PVB. The system includes an extraction station for extraction with liquid carbon dioxide at a pressure between 30 and 70 bar, and at a temperature between −20° C. to 30° C. The extraction station comprises a sealable container with means for introducing pressurized liquid carbon dioxide into the container and means for stirring PVB material. In particular, the sealable container is a rotating drum, which is typically suitable for processing that implements liquid carbon dioxide. The station further includes transfer means for transferring the pressurized liquid carbon dioxide containing extracted plasticizer and/or contaminants from the container to a distillation unit. The distillation unit separates extracted plasticizer and/or contaminants from the carbon dioxide, by evaporation of the liquefied CO₂. The system further includes pressurizing means, such as a compressor, for pressurizing and liquefying of the CO₂ evaporated in the distillation unit. U.S. Pat. No. 10,626,241 insists upon its method being more environmentally friendly than the method according to U.S. Pat. No. 5,739,270 because it eliminates the use of organic solvents and reduces the pressure at which the CO₂ is applied to the extraction process.

### SUMMARY OF THE INVENTION

According to an aspect of the invention, a method of processing PVB, in particular waste PVB, comprises providing solid, post-consumer or post-industrial PVB, e.g., in the form of flakes, powder, or granules or in another granular, particulate form, extracting plasticizer from the PVB with supercritical carbon dioxide, i.e., carbon dioxide at a temperature above its critical temperature of 31° C. and pressurized above its critical pressure of 7.3773 MPa (73.773 bar). The inventors have found that, surprisingly, efficient plasticizer extraction is possible from solid-state PVB particulate matter using supercritical CO₂ (the PVB particles are not melted before or during the extraction). The PVB obtained after (partial) extraction of the plasticizer may hereinafter be referred to as “PVB recyclate” or “deplasticzed PVB”.

The PVB is preferably placed into a pressure vessel through which supercritical CO₂ is circulated during the extraction. The extraction process may be carried out batchwise or, alternatively, as a continuous process, wherein waste PVB is introduced into the extraction vessel, where it is exposed to the flow of supercritical CO₂, and removed from it without interrupting the flow of supercritical CO₂ or interrupting it only for a short time, compared to the time required to open the extraction vessel and close it again. The vessel wherein the extraction method is performed may hereinafter be referred to as “pressure vessel” or “extraction vessel”.

The extraction may be carried out with supercritical CO₂ at a pressure in the range from 150 to 500 bar, preferably from 200 to 450 bar, more preferably from 250 to 450 bar, and at a temperature in the range from 35° C. to 70° C., preferably from 40° C. to 65° C., more preferably in the range from 45° C. to 60° C., and still more preferably from 45° C. to 55° C. According to another embodiment, the extraction may be carried out with supercritical CO₂ at a pressure in the range from 80 to 500 bar, preferably from 100 to 450 bar, more preferably from 150 to 400 bar, and a temperature in the range from 33° C. to 70° C., preferably from 35° C. to 60° C., and more preferably from 38° C. to 45° C. It has been found that at temperatures below 60° C., and at pressures in the indicated pressure windows, the supercritical CO₂ does not plasticize the PVB resin to an extent that would cause (too many of) the individual particles (e.g., flakes, granules, or powder) to agglomerate together upon decompression. On the other hand, the conditions of pressure and temperature enable satisfactory extraction of plasticizer. The feed PVB particles are preferably supplied in the form of granules, minute chunks, powder, and more preferable in the form of flakes (chips, pieces of PVB film or PVB foil). PVB powder may be obtained by crushing, grinding, or micronization of larger PVB particles. The process for preparing the PVB powder may preferably be carried out at ambient conditions (for instance between 15° C. to 25° C., at atmospheric pressure). Alternatively, to avoid any PVB sticking issue, PVB powder may be prepared by cryogenic processing (i.e., by submitting PVB particles to cryogenic conditions) followed by a step of crushing, grinding, or micronization.

PVB powder for use in the process may preferably have a D50 diameter in the range from 20 μm to 2000 μm, preferably from 100 μm to 1000 μm, more preferably from 200 μm to 600 μm and most preferably from 400 μm to 500 μm.

PVB powder for use in the process may preferably have a D10 diameter in the range from 10 μm to 1000 μm, preferably from 20 μm to 800 μm, more preferably from 50 μm to 500 μm and most preferably from 80 μm to 120 μm.

PVB powder for use in the process may preferably have a D90 diameter in the range from 100 μm to 1500 μm, preferably from 300 μm to 1200 μm, more preferably from 500 μm to 1000 μm and most preferably from 700 μm to 800 μm.

PVB flakes for use in the process may, preferably, have an average thickness less than or equal to 1 mm. Preferably, the average thickness of the PVB particles lies in the range from 100 μm to 1.6 mm, preferably in the range from 300 μm to 800 μm.

PVB flakes may have an average diameter from 1 mm to 10 mm, preferably from 1 mm to 50 mm, more preferably from 1 mm to 30 mm, or from 1 mm to 10 or 20 mm. Preferably, the PVB flakes may have a D10 diameter in the range from 1 mm to 5 mm, a D90 diameter in the range from 15 mm to 30 mm and a D50 diameter in the range from 4 mm to 22 mm.

The extraction may be conducted with a solvent-to-feed mass ratio of at least 10, preferably at least 15 and more preferably at least 20. The solvent-to-feed mass ratio is obtained by dividing the mass of the CO₂ circulated across the PVB particulate matter (the feed), including any cosolvent, by the mass of the PVB flakes.

According to one embodiment, the extraction may preferably be conducted in a pressure vessel, which is a wall-heated fixed bed reactor (or jacketed reactor), wherein the wall is heated at a temperature from 33° C. to 80° C., more preferably from 40° C. to 60° C. This allows implementing the extraction on high volumes of PVB material resulting in a yield-effective and cost effective method which is suitable for industrial-scale production.

The post-consumer or post-industrial PVB may preferably have an (initial) plasticizer content of at least 23% by weight, or at least 24 or 25% by weight. The post-consumer or post-industrial PVB may advantageously comprise from 17 wt. % to 23 wt. %, preferably from 18 wt. % to 21 wt. %, still more preferably from 19 wt. % to 21 wt. %, vinyl alcohol (VA). Preferably, the PVB comprises at most 4 wt. % VAc, preferably at most 3 wt. % VAc, more preferably at most 2 wt. % VAc, still more preferably at most 1.5 wt. % VAc and most preferably at most 1 wt. % VAc.

The post-consumer or post-industrial PVB may have a content in residual glass particles of less than 2% by weight, preferably less than 1% by weight, more preferably less than 0.5% by weight and still more preferably less than 0.1% by weight.

After the extraction of plasticizer, the PVB may have a residual plasticizer content of at most 15% by weight, preferably of at most 10% by weight, more preferably of at most 7% by weight, still more preferably of at most 5% by weight, yet more preferably of at most 3% by weight, even more preferably of at most 2% by weight, and most preferably of at most 1.5% by weight.

According to a specific embodiment, the extraction of plasticizer may be conducted on PVB flakes or granules until the residual PVB plasticizer content is in the range from 5% to 15% by weight and preferably in the range from 8% to 12% by weight.

According to another embodiment, the extraction of plasticizer is conducted on PVB powder until the residual PVB plasticizer content is at most 5 wt % and preferably at most 1 wt % by weight.

Additionally, or alternatively, after the extraction of plasticizer, the PVB may have a residual plasticizer content of at most 50%, preferably of at most 30%, more preferably of at most 20%, still more preferably of at most 15%, yet more preferably of at most 10%, even more preferably of at most 5%, and still even more preferably of at most 2% by weight, and most preferably of at most 1%, of the initial plasticizer content of the PVB.

Supercritical carbon dioxide laden with plasticizer extracted from the PVB may be expanded to release plasticizer and recirculated at least in part. The supercritical, plasticizer-carrying, CO₂ may be led into a distillation apparatus, where it is expanded to release the plasticizer, which may condensate in the distillation apparatus. The purified CO₂ may be recovered. Part or all of the CO₂ may be pressurized again, brought to the supercritical state, and reinjected into the flow of supercritical CO₂ that is led across the waste PVB.

According to embodiments of the invention, the extraction may be conducted with supercritical carbon dioxide without any further cosolvent, in particular, without any of the cosolvents specifically mentioned hereinafter. According to alternative embodiments, the extraction may be conducted with supercritical carbon dioxide with one or more cosolvents. The one or more cosolvents could be selected from methanol, ethanol, propanol, butanol, acetone, or mixtures thereof. If one or more cosolvents are used, the mass ratio of the one or more cosolvents to the supercritical carbon dioxide preferably does not exceed 15%.

A particularly preferred embodiment of the invention is defined by the combination of claims 1 to 10. The extraction may in this case be conducted with or without a cosolvent, preferably a cosolvent selected among the cosolvents mentioned above. If one or more cosolvents are used, the mass ratio of the one or more cosolvents to the supercritical carbon dioxide preferably does not exceed 15%.

After extraction of plasticizer, the pressure vessel containing the PVB may be decompressed, e.g., to atmospheric pressure, for removal of the deplasticized PVB. The pressure in the pressure vessel containing the PVB at the end of the extraction step may be in the range from 80 bar to 500 bar. The PVB decompression may preferably be carried out in a controlled manner. During the decompression, CO₂ that has been adsorbed into the PVB may cause the PVB to swell. PVB particles may thus be firmly pressed together and form a foamed block of PVB, which may be undesirable in some applications. Swelling of the PVB may be avoided by gradual (slow) decompression. According to an embodiment, the decompression rate may be comprised in the range from 0.05 bar/min to 2 bar/min. To some extent, the maximum acceptable decompression rate may depend on temperature (and other parameters). It should be noted that the maximum acceptable decompression range may be readily determined by trial and error in a given experimental or industrial setup. According to an embodiment, after the plasticizer extraction, the PVB decompression is performed in two successive steps:
1) a step of fast decompression at a decompression rate which is in the range from 5 bar/min to 30 bar/min, preferably from 15 bar/min to 25 bar/min, until the pressure within the pressure vessel is in the range from 20 to 50 bar, and
2) a step of slow decompression at a decompression rate which is in the range from 0.05 bar/min to 4 bar/min, preferably from 0.5 to 1.5 bar/min, until the pressure within the pressure vessel is the atmospheric pressure.

The two-step decompression allows preventing swelling of the PVB in the pressure vessel, which may, preferably, be a wall-heated fixed-bed reactor. Without being bound by any theory, one may assume that when decompressing, the temperature of the mixture comprising PVB and CO₂ drops, which leads to the formation of a dense liquid CO₂. The heating of the wall of the fixed-bed reactor allows supplying energy into the mixture of PVB and CO₂ to improve the evaporation of the liquid CO₂. However, the center of the wall-heated fixed-bed reactor may not benefit from this heating since it is remote from the heated wall. As a result, dense liquid CO₂ might remain within PVB, since the temperature of the PVB is still low, thus causing the unwanted swelling of PVB when the pressure is decreased. The controlled decompression allows a good diffusion of the heat within the mixture of PVB and CO₂ and thus optimizes the evaporation of the liquid CO₂, limiting significantly the swelling effect.

Additionally, or alternatively, the pressure vessel containing the PVB may be decompressed to an intermediate pressure range in which a filler fluid (e.g., air, argon, N₂, etc.) is introduced into the pressure vessel so as to replace at least part of the carbon dioxide contained therein, and the pressure vessel containing the PVB may then be decompressed to a final pressure (e.g., atmospheric pressure). Substitution of part of the CO₂ by a filler fluid at an intermediate pressure may help to evacuate adsorbed CO₂ from the PVB and thereby reduce its swelling potential. The intermediate pressure range may be located between the pressure at which the plasticizer extraction is effected and the pressure at which the PVB is removed from the vessel. The intermediate pressure range in which CO₂ is replaced by the filler fluid is preferably selected above the pressure where the swelling of the PVB is observed. Depending on the specific conditions (temperature, vessel volume, PVB particle size, etc.), the intermediate pressure range could be from 5 to 50 bar, preferably from 7 to 30 bar, or more preferably from 8 to 20 bar.

A further aspect of the invention relates to a recyclate comprising PVB obtained by the process as described herein.

Yet a further aspect of the invention relates to a method for producing a decorative surface covering, e.g., a floor covering, wallcovering or ceiling covering, preferably a (substantially) PVC-free surface covering. The method may comprise sourcing PVB (with a reduced plasticizer content) using an extraction method as described, forming a PVB-based thermoplastic core layer with the PVB, covering the PVB-based thermoplastic core layer with a wear layer and, optionally, backing the PVB-based thermoplastic core layer with a backing layer. The method may also comprise arranging a décor layer, e.g., a digitally printed décor layer, between the PVB-based thermoplastic core layer and the wear layer. The formation of the PVB-based thermoplastic core layer may be performed, at least in part, by extrusion, co-extrusion, or by compaction of pre-compounded granules of thermoplastic material.

The décor layer could comprise a printing substrate and a decorative print thereon or a decorative print directly printed on the core layer. The wear layer is preferably transparent or translucent. The wear layer optionally comprises or consists of a crosslinked topcoat (e.g., comprising epoxy, polyurethane, polyurethane acrylate, polyester polyurethane acrylate, polyurethane methacrylate and/or polyester polyurethane methacrylate). The wear layer and/or the décor layer could also comprise an embossed pattern in register with the decorative print. The wear layer and the topcoat could each comprise or be built from one or plural layers. These could be distinguishable from each other in the final product or not. The decorative print may comprise a digital print or a print generated by analogous printing technique such as, e.g., rotogravure, photogravure, offset printing, or the like.

An interesting advantage of using recycled, deplasticized PVB in decorative surface coverings resides in reduced carbon footprint.

As used herein, the expression “substantially PVC-free” is used to qualify a surface covering comprising less than 0.5%, preferably less than 0.2%, more preferably less than 0.1%, most preferably less than 0.05%, by weight of PVC (polyvinyl chloride). The surface covering may comprise a core layer, a décor layer or décor layer assembly, and, optionally, a backing layer.

The core layer into which the PVB recyclate is incorporated may be a stiff core layer possessing a deformation angle of less than 10 degrees, preferably of less than 7 degrees, more preferably of less than 5 degrees, most preferably of less than 3 degrees, as measured by the following deformation test (cantilever test) carried out in ambient conditions of temperature and pressure (at 23° C. and at atmospheric pressure, i.e., about 1000 hPa). According to the deformation test, a rectangular sample (in this case of the core layer) with dimensions of 160 mm×450 mm, is clamped in a horizontal cantilevered position so as to obtain a 160×300 mm projecting part of the sample. The projecting portion is initially supported over its entire length and width by a removable horizontal support. The deformation angle is measured 30 seconds after removal of the support that prevents the deformation of the projecting part under the influence of its own weight. The deformation angle is a measure of the flexural strength of the structure being tested. According to an embodiment, the core layer may have a flexural modulus of over 500 MPa, preferably over 1000 MPa, more preferably over 1500 MPa, and most preferably over 3000 MPa. According to another embodiment, the core layer may have a flexural modulus of less than 20 000 MPa, preferably of less than 12 000 MPa and more preferably of less than 10 000 MPa. Preferably, the core layer has a flexural modulus which is comprised in between 1000 MPa and 10 000 MPa. The flexural modulus may be determined from the slope of a stress-strain curve produced by a flexural test (3-point bending test) measured on a 50 mm wide×80 mm long sample (the length extension corresponding to the machine direction), at ambient temperature and pressure conditions.

The core layer may comprise a thermoplastic material containing the PVB recyclate. The thermoplastic material preferably has a plasticizer content (overall plasticizer content) of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, yet more preferably of not more than 3 wt. %, still more preferably of not more than 2 wt. %, and most preferably of not more than 1 wt. %, with respect to the PVB content. According to a specific embodiment, the core layer may have a plasticizer content from 5 wt. % to 18 wt. % with respect to the PVB content and more preferably from 8 to 14 wt. % with respect to the PVB content. When reference is made herein to the PVB content, this means the amount of PVB polymer (resin), not including any plasticizer, additive or contaminant.

It may be noted that the core layer may be configured with a unique layer or plural layers (core layer assembly).

The optional backing layer may comprise one or more resilient foam layers and/or one or more textile layers.

The core layer may comprise one or more reinforcement layers, such as, e.g., glass or fibre veils, glass or fibre grids, textile layers, etc., the one or more reinforcement layers being embedded in or adjacent to the thermoplastic material containing the deplasticized PVB (PVB recyclate). The core layer may comprise two or more thermoplastic materials, e.g., arranged in different layers.

A particularly preferred core layer assembly may comprise three or more layers, including two outer layers sandwiching one or more inner layers. In this case, the outer layers may preferably comprise a first thermoplastic material, while the one or more inner layers comprise at least a second thermoplastic material different from the first one. Preferably, the outer layers are of (essentially) the same chemical constitution. The outer layer may have the same thickness or be of different thicknesses. The first thermoplastic material of the outer layers is preferably the thermoplastic material containing PVB recyclate. The thermoplastic material of the inner layer(s) could be a different thermoplastic material containing PVB recyclate. It should, however, be noted that the inner layer(s) could, alternatively, comprise a thermoplastic PVB material having a higher plasticizer content, e.g., a less deplasticized PVB recyclate.

The presence of deplasticized recycled PVB within the thermoplastic material may be detected due to the presence of residual contaminants, in particular, glass particles or plasticizers, which have not been removed during the extraction process. Recycled PVB is typically sourced from laminated glass by mechanical peeling or mechanical cracking followed by chemical separation in aqueous alkali solution. Although separation may be efficient, a residual content of glass particles may characterize the recycled PVB.

It was found that the lower the plasticizer content of the PVB recyclate, the better are normally the properties of a surface covering containing the PVB recyclate. Nevertheless, experimental product tests showed that satisfactory results can already be reached if the plasticizer content of the thermoplastic material does not exceed 20 wt. % with respect to the PVB content. Better results may be achieved when the plasticizer content of the thermoplastic material does not exceed 15 wt. %, more preferably 12.5 wt. %, with respect to the PVB content.

The surface covering may take the form of a surface covering tile comprising a first locking profile along a first edge, a second locking profile along a second edge, the first and second locking profiles being complementary so that the surface covering tile can be interlocked with another surface covering tile by engaging the first or the second locking profile of the surface covering tile with the second or first locking profile of the other surface covering tile. A method for producing a decorative surface covering tile may thus advantageously comprise forming the locking profiled by cutting, milling and/or grinding.

The expression “surface covering tile” preferably designates a piece of surface covering, such as, e.g., a tile, a plank, a panel, or the like, which can be assembled with other pieces of flooring so as to serve as a finish on a surface, e.g., an underfloor. Preferred examples of surface covering tiles include flooring tiles, in particular, rigid flooring tiles.

The plasticizers (at least partially) extracted with the supercritical CO₂ may include aliphatic diesters of tri- or tetraethylene glycols, e.g., triethylene glycol bis(2-ethylhexanoate), esters of multivalent acids, polyhydric alcohols or oligoether glycols, such as, e.g., adipic acid esters, sebacic acid esters, ricinoleic acid esters, citric acid esters, or phthalic acid esters, in particular di-n-hexyl adipate, dibutyl sebacate, dibutyl maleate, dioctyl phthalate, esters of ethylene glycol, diglycol, triglycol or tetraglycol with linear or branched aliphatic carboxylic acids and mixtures of these esters. The post-consumer or post-industrial PVB solid particles used as the feed of the extraction process may further comprise esters of aliphatic diols with long chain aliphatic carboxylic acids, in particular esters of triethylene glycol with aliphatic carboxylic acids containing 6 to 10 C atoms, such as 2-ethyl butyric acid or n-heptanoic acid, di-n-hexyl adipate, dibutyl sebacate, dioctyl phthalate, esters of diglycol, triglycol or tetraglycol with linear or branched aliphatic carboxylic acids, in particular triethylene glycol-bis-2-ethyl butyrate, triethylene glycol-bis-n-heptanoate, tetraethylene glycol-bis-n-heptanoate. Ethers of ethylene glycol may also be considered as plasticizers.

The thermoplastic material containing the PVB recyclate may comprise dispersing one or more fillers therein. Incorporation of filler may, however, not be needed in certain embodiments. Filler contents from 10 to 500 wt. % with respect to the PVB content (10 to 500 phr) may be chosen. Advantageously, a filler content from 50 to 400 wt. %, preferably from 80 to 300 wt. %, more preferably from 100 to 250 wt. % with respect to the PVB content, may be chosen. The filler may comprise organic filler material such as, e.g., ground cork, wood flour, cellulose fibers, bleached chemical wood pulp, etc., and/or mineral filler material such as, e.g., ground limestone, chalk, magnesium carbonate, dolomite, clay, silica, aluminium trihydroxide, magnesium dihydroxide, precipitated calcium carbonate, glass fibers and/or glass particles, etc. Lamellar or fibrous fillers may be incorporated into the thermoplastic material(s) of the core layer to advantageously modify the mechanical properties of the thermoplastic material, e.g., the thermal expansion coefficient. Fibrous fillers usable in the context of embodiments of the invention may include glass fibers, or biomass fibers, like bamboo fibers, hemp fibers, flax fibers, wood fibers, etc., preferably delignified cellulosic fibers. Particularly preferred fillers may include inorganic lamellar fillers, such as, e.g., sheet silicate (in particular, talc or mica), clay, montmorillonite, glass flake, and lamellar double hydroxide. The term “sheet silicate” refers to minerals from the group of silicates wherein the silicate anions are usually arranged in layers, e.g., phyllosilicates. By way of example, phyllosilicates may include minerals from the mica group, the chlorite group, the kaolinite group, and the serpentine group. The filler or part of the filler may be or include biochar, i.e., solid material, rich in carbon, obtained by thermochemical conversion of biomass in an oxygen-poor environment (reducing atmosphere) or by thermo-catalytic depolymerization of biomass. The thermoplastic material may have a biochar content from 50 to 400 wt. %, preferably from 80 to 300 wt. %, more preferably from 80 to 250 wt. %, and still more preferably from 80 to 100 wt. %, with respect to the PVB content.

Forming the thermoplastic material containing the PVB recyclate may include incorporation of one or more additives, such as, e.g., lubricant(s), stabilizer(s), filler compatibilizer(s). The additives content of the thermoplastic material may be limited to 10 wt. % or less, e.g., to 8 wt. % or less or 7 wt. % or less, with respect to the PVB content.

The PVB of the thermoplastic material may comprise at least 50 wt. %, preferably at least 60 wt. %, more preferably at least 70 wt. %, still more preferably at least 80 wt. %, yet more preferably at least 90 wt. %, and most preferably 100 wt. %, of deplasticized recycled PVB.

Optionally, one may incorporate into the thermoplastic material synthetic polymers other than PVB. Preferably, thermoplastic material is made with at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

The method may comprise foaming the thermoplastic material of the core layer.

The core layer may be fabricated by direct extrusion through a flat die. In case of a core layer assembly, co-extrusion may be used. As an alternative, the core layer (assembly) may be obtained by compaction (under heat and pressure) of precompounded granules of thermoplastic material.

As used herein, the expression “flake”, may designate a solid (macroscopic) particle, e.g., a chip or a piece of PVB foil scrap, which is significantly thinner than it is long and wide. Flakes usable in the context of the present invention may be or comprise foil scrap pieces. PVB flakes preferably have an aspect ratio below 0.3, more preferably below 0.2, still more preferably below 0.15, yet more preferably below 0.10, even more preferably below 0.07. The term “solid” refers to the solid state of matter (as opposed to liquid, gas, and plasma).

Unless contradicted by context, when reference is made herein to the “diameter” of a particle (e.g., a flake of waste PVB), what is meant is the maximum distance between two parallel planes tangent to the particle that can be measured for that particle. In other words, the diameter of a particle corresponds to the greatest of all Feret diameters that can be measured for the particle. The Feret diameter along a specified direction is defined as the distance between two parallel planes tangent to the particle and orthogonal to the specified direction. The expression “aspect ratio”, as used herein, refers to the ratio between the shortest and the longest Feret diameters of a particle. The shortest Feret diameter of a solid particle corresponds to the thickness of the particle. When the expression “aspect ratio” is used to qualify a set of particles (such as, e.g., a quantity of PVB flakes), it designates the ratio between the average shortest Feret diameter to the average longest Feret diameter. The D50 diameter designates the median diameter of the particles of a given set, i.e., the value at or below which 50% of the particle diameters in the given set are found. The expressions “D10 diameter” and “D90 diameter” designate the values at or below which 10% and 90%, respectively, of the particle diameters in the given set are found. For particles having typical sizes in the range from 1 to 10 mm (or more), the D10, D50 and D90 diameters may be advantageously determined by sieving.

Terms such as “up”, down”, “lower”, “upper”, “horizontal”, “vertical”, “above”, “below”, “top” and “bottom” as well as derivatives thereof (e.g., “horizontally”, “upwards”, etc.) refer to the orientation of a surface covering tile laid with its decorative face oriented upwards. For a flooring tile or flooring, this orientation corresponds to the position of the flooring tile or flooring when in use, i.e., laid on the floor. The terms referring to orientation of the surface covering are employed herein for convenience of description and as a naming convention. They shall be construed to refer to the relative orientation of the different parts but are not meant to imply a particular absolute orientation of the tile or flooring component in space. E.g., arranging a tile with its decorative face upside down shall not prevent the decorative face from being considered the top surface.

The qualifier “decorative”, as used herein, is intended to imply that the item thereby qualified, such as the surface covering, remains visible in normal use (as an item of finishing work). The use of the term, should not, however, be taken to imply any particular aesthetic appearance or any particular aesthetic design. The expression “décor layer” designates a layer with a decorative motif. Examples of décor layers include print layers, in particular, rotogravure-printed layers and digitally printed layers.

The expression “surface normal” refers to the direction perpendicular to the surface of the decorative side (the top side) of the surface covering.

As used herein, the expression “thermoplastic material” encompasses plastic polymer material blends that become pliable or moldable at a certain elevated temperature and solidify upon cooling, the solidification being reversible by heating the material again to the elevated temperature. Thermoplastic (polymer) material may comprise thermoplastic polymers and, optionally, one or more plasticizers, (mineral or organic) fillers, and further additives (e.g., impact modifiers, compatibilizers, processing aids). Thermoplastic polymers include, for example: polyacrylic acid, polyacrylate, polyamide, polyester, polylactic acid (PLA), polycarbonate, polyether sulfone (PES), polyether ether ketone (PEEK), polyetherimide (PEI), polyethylene, polypropylene (PP), polystyrene, polyvinyl butyral (PVB). polyvinyl chloride (PVC), polyvinylidene fluoride (PVDF), acrylonitrile butadiene styrene (ABS), cellulose ester, etc. In the present context, at least one of the thermoplastic materials of the core layer comprises deplasticized recycled PVB. Other thermoplastic polymers may be present in the thermoplastic material but according to preferred embodiments, the thermoplastic material comprises significantly less other synthetic polymers (in particular thermoplastic polymers) than PVB. In the context of the present document, two or more initially separate thermoplastic materials that have been intimately blended together have to be considered, in their blended state, as one thermoplastic material. Accordingly, when reference is made herein to a surface covering or any component thereof comprising two or more thermoplastic materials, it is understood that these two or more thermoplastic materials are present in physically separate volumes, e.g., in different layers, in different distinguishable granules, or the like.

In contrast to “thermoplastic”, the expression “crosslinked” qualifies polymer material (such as, e.g., a topcoat) that has been irreversibly hardened through crosslinking between polymer chains so as to generate an infusible and insoluble network of polymer. Crosslinked (polymer) material may include, e.g., one or more thermoset or radiation-cured polymers. Radiation-cured polymers include, in particular, UV-cured and/or electron-beam-cured polymers. Crosslinked (polymer) material may comprise thermoset and/or radiation-cured polymers (e.g., polyurethane, polyimide, epoxy, etc.) and, optionally, one or more plasticizers, (mineral or organic) fillers, and further additives (e.g., impact modifiers, photoinitiators, antioxidants, etc.) or processing aids.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance, hierarchy, or limitation in number is intended to be implied by the use of these expressions. Furthermore, when plural instances of an object are referred to by ordinal numbers, this does not necessarily mean that no other instances of that object are present (unless this follows clearly from context). When this description refers to “an embodiment”, “one embodiment”, “embodiments”, etc., this means that the features of those embodiments can be used in the combination explicitly presented but also that the features can be combined across embodiments without departing from the invention, unless it follows from context that features cannot be combined.

(Residual) plasticizer content may be measured using different methods. For instance, nuclear magnetic resonance (NMR) could be used, e.g., a MQC23+ Benchtop NMR Analyzer (Oxford Instruments) could be employed. Alternative methods for measuring the plasticizer content include dissolving the plasticizer in organic solvent and determining the plasticizer content by gravimetric analysis following distillation, gas chromatography and/or infrared spectroscopy. The preferred method uses DMA (dynamic mechanical analysis) to determine the glass transition temperature Tg of a sample in accordance with ISO 6721-11:2019 (determination of the temperature of the peak in the curve of loss factor (tan (delta)) vs. temperature). Procedure B of ISO 6721-11:2019 may be used (temperature rate of 2.5 K/min; frequency of 1 Hz). If the sample is of known composition (except for the plasticizer content), the plasticizer content is derived from a calibration curve or calibration table (lookup table) linking the Tg to the plasticizer content for the given composition. If the composition of the sample is not initially known, the different components (resin, filler, plasticizer species, etc.) thereof are determined in a first step. Different comparative samples are then prepared with different precisely metered contents of plasticizer and the calibration curve or calibration table (lookup table) linking the Tg to the plasticizer content for the given composition is determined by measuring the Tg of the comparative samples in accordance with ISO 6721-11:2019 using the tan (delta) method. The plasticizer content of the sample under examination may then be determined using the calibration curve or calibration table. Indications of plasticizer content in this document refer to the preferred method based on the determination of the glass temperature and reference values (calibration curve(s) or table(s)).

### BRIEF DESCRIPTION OF THE DRAWINGS

By way of example, preferred, non-limiting embodiments of the invention will now be described in detail with reference to the accompanying drawings, in which:

FIG. 1: is a schematic diagram of a (simplified) supercritical CO₂ extraction equipment;

FIG. 2: is a cross-sectional schematic view of a surface covering tile containing deplasticized PVB obtained in accordance with a process of the invention;

FIG. 3: is an illustration of the deformation test, showing the cantilevered sample in the initial supported position; and

FIG. 4: is an illustration of the deformation test, showing the cantilevered sample after removal of the support of the projecting portion.

### DETAILED DESCRIPTION OF PREFERRED EMBODIMENTS

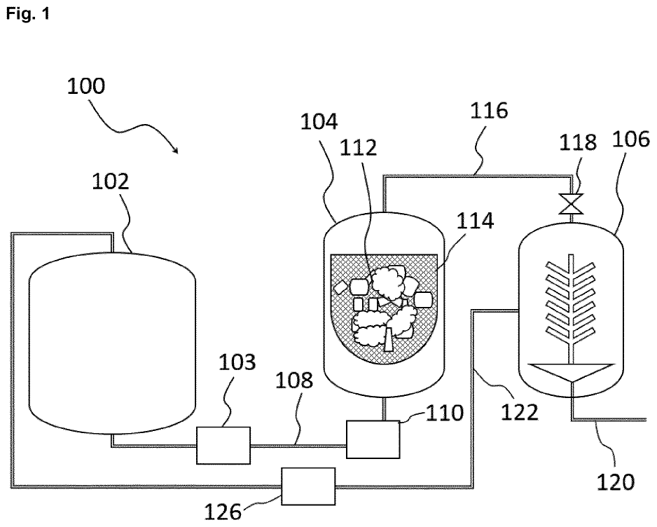

A preferred system 100 for processing waste PVB in the form of solid particles, such as e.g., flakes, is illustrated in FIG. 1. The system 100 comprises, as main components, a CO₂ storage container 102, an extraction vessel 104 and a distillation apparatus 106. The storage container contains CO₂ at a pressure in the range from 20 to 70 bar at a temperature between −20° C. and 30° C., preferably at a pressure in the range from 40 to 65 bar at a temperature between 0 and 20° C. CO₂ from the storage container 102 pressurized with a pump 103 to a pressure from 80 to 500 bar, preferably from 100 to 450 bar, and more preferably from 150 to 400 bar. The pressurized CO₂ is then supplied to the extraction vessel 104 through a supply pipe 108 and a heater 110, which heats the CO₂ to the desired temperature in the range from 33° C. to 70° C., preferably from 35° C. to 60° C., more preferably in the range from 38° C. to 45° C.

The extraction vessel 104 is charged with PVB particles 112. The PVB particles 112 may be loosely bagged in a permeable bag or held in a basket 114. The extraction vessel 104 may preferably be a heated-wall fixed-bed reactor. Before the extraction vessel 104 is flooded with CO₂, a vacuum may be applied to remove air and, possibly, certain contaminants, e.g., volatile organic compounds.

In the extraction vessel, the supercritical CO₂ dissolves the plasticizer contained in the PVB particles. The plasticizer-laden CO₂ is then transferred to the distillation apparatus, via a transfer pipe 116. The plasticizer-laden CO₂ is expanded through an expansion valve 118 so that it releases the plasticizer in the distillation apparatus 106, which preferably operates between 20 to 70 bar and between −20° C. and 50° C., more preferably from 40 to 65 bar and between 2° and 40° C. The plasticizer condensates in the distillation apparatus 106 and is withdrawn via a liquid outlet 120. The expanded, now gaseous CO₂ is withdrawn from the distillation apparatus through a gas outlet 122. Part or all of the CO₂ may be recirculated to a condenser 126 to be liquefied and sent back to the storage container 102.

FIG. 1 illustrates plasticizer extraction with supercritical CO₂ without another cosolvent. However, should a cosolvent be desired or be necessary, this cosolvent would be provided from a cosolvent storage container and be adduced into the supply pipe 108 or into the extraction vessel 104. Depending on the nature of the cosolvent, it may condensate into the liquid fraction obtained in the distillation apparatus, in which case the cosolvent is not recirculated together with the flow of CO₂ (but could be recirculated separately, after separation of the cosolvent from the plasticizer).

LVT flooring assembled by click is one of the fastest-growing flooring categories due to the numerous advantages (easy installation, suitable for renovation including uneven subfloors, water tightness . . . ) The core layer of those products is quite thick (e.g., 3-6 mm) and often semi-rigid or rigid (stiffness ranging from 0.5-2 GPa and from 2 GPa-10 GPa (or higher) respectively). Generally, filled PVC is used as matrix polymer but there is a growing demand for alternatives to PVC (compliance with some local regulations, concerns with PVC in some regions . . . ) suitable for LVT floorings. According to an aspect of the present invention, producing LVT flooring (or other decorative surface coverings) containing deplasticized recycled PVB is proposed. According to a particularly preferred aspect, PVB-based flooring tiles are produced substantially or completely PVC-free.

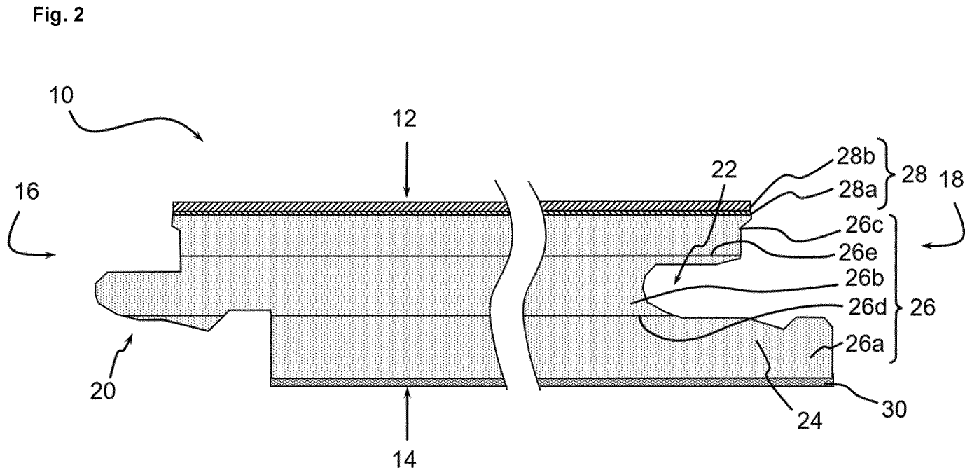

FIG. 2 shows a “vinyl”-type flooring panel 10. The flooring panel 10 may be a rigid luxury vinyl tile (LVT). The flooring panel 10 has a having a top surface 12, a bottom surface 14 and at least four side edges. FIG. 2 shows a first edge 16 and a complementarily shaped second edge 18 in more detail. The first edge 16 may comprise a first locking profile featuring a tongue 20 and the second edge 18 may comprise a second locking profile featuring a groove 22. The first and second locking profiles may be configured mutually complementarily for mechanically engaging and interlocking with a second and a first connection profile, respectively, of another flooring panel of the same type. Specifically, the tongue 20 and the groove 22 may be complementarily shaped, so as to enable a tongue-and-groove connection between neighboring panels. The groove 22 may be delimited at its bottom by a base 24.

The flooring panel 10 may be of a layered structure and include a core layer 26 and a décor layer assembly 28 arranged on the core layer 26. The core layer 26 may be rigid. The décor layer assembly 28 may comprise a print layer 28a (e.g., a printing substrate carrying one or more digital printed ink layers) and a transparent or translucent wear layer 28b. The print layer 28a could also be printed directly on the core layer 26. As a further possibility, the print layer 28a could be printed on the backside of the wear layer 28b before the wear layer 28b and the core layer are laminated so as to sandwich the print layer 28a. A backing layer 30, e.g., a resilient foam layer, a felt layer or a fleece layer, may be arranged on the bottom side 14 of the flooring panel 10.

The core layer 26 may comprise plural sublayers, e.g., one or more deplasticized-recycled-PVB-based thermoplastic layers 26a, 26b, 26c and one or more reinforcing fiber layers 26d, 26e. Fiber layers 26d, 26e may comprise veils, grids or textiles made from reinforcing fibers, e.g., glass fibers, aramid fibers, ultra-high-molecular-weight polyethylene (UHMWPE) fibers, or the like. The one or more fiber layers 26d, 26e may be embedded in or adjacent to the one or more PVB-based thermoplastic layers 26a, 26b, 26c. If the core layer 26 comprises plural PVB-based thermoplastic sublayers 26a, 26b, 26c, these may be made from thermoplastic materials of the same or two or more different compositions. It may be worthwhile noting, however, that the core layer 26 could, alternatively, comprise the same PVB material throughout its height.

The flooring panel 10 may have an overall height in the range from 2 to 10 mm, preferably in the range from 2.5 mm to 9 mm, and most preferably in the range from 2.5 mm to 8.5 mm.

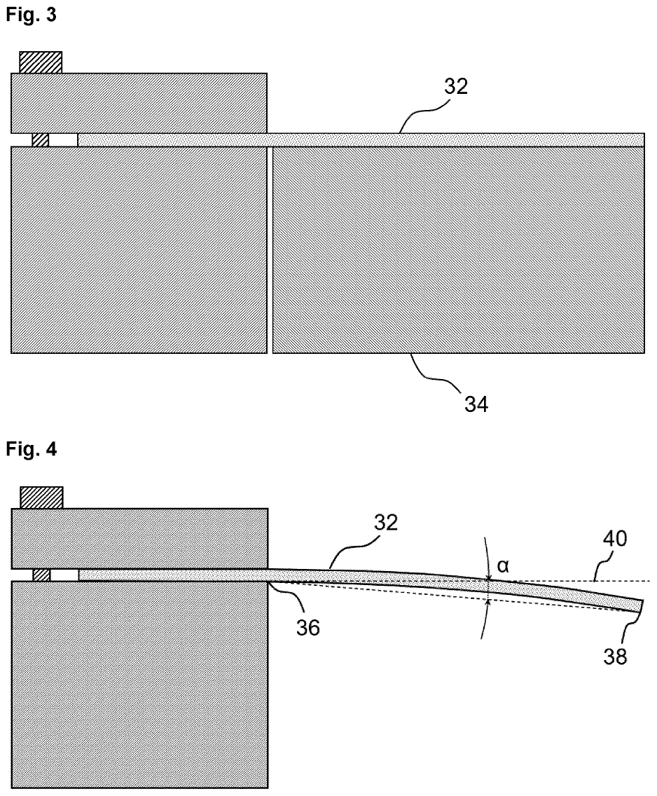

The core layer 26 may be configured such that it possesses a deformation angle (α) of less than 10 degrees, preferably of less than 7 degrees, more preferably of less than 5 degrees, most preferably of less than 3 degrees, as measured by the deformation test. To carry out the deformation test, illustrated in FIGS. 3 and 4, a 160 mm×450 mm rectangular sample 32 of the core layer 26 (including sublayers 26a, 26b, 26c, 26d, 26e in the illustrated embodiment) or other layer (assembly) is prepared. The sample 32 is than is clamped in a horizontal cantilevered position so as to obtain a 160×300 mm rectangular projecting part of the sample. The projecting part is initially supported over its entire length and width by a removable horizontal support. This support is then removed so that the projecting part bends under its own weight. The deformation angle α is measured 30 seconds after removal of the support 34 that prevents the deformation of the projecting part under the influence of its own weight. The deformation angle α corresponds to the angle between the horizontal support plane 40 and the plane extending from the edge 36 of the support from which the projecting portion projects to the lowermost extremity 38 of the projecting portion.

The PVB-based thermoplastic material(s) of the core layer 26 may have a plasticizer content (overall plasticizer content) of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, yet more preferably of not more than 3 wt. %, and still more preferably of not more than 2 wt. %, with respect to the PVB content. More specifically, the PVB-based thermoplastic material(s) include a content of plasticizers being aliphatic diesters of tri- or tetraethylene glycols (such as, e.g., triethylene glycol bis(2-ethylhexanoate)) from 0.1 wt. % to 19.5 wt. %, preferably from 0.1 wt. % to 15 wt. %, preferably from 0.1 wt. % to 10 wt. %, preferably from 0.1 wt. % to 5 wt. %, more preferably from 0.1 wt. % to 2 wt. %, still more preferably from 0.1 wt. % to 1 wt. %, and most preferably from 0.1 wt. % to 0.5 wt. % with respect to the PVB content.

At least one of the PVB-based thermoplastic materials of the core layer(s) includes deplasticized recycled PVB obtained from the plasticizer extraction process disclosed above. The extraction process is, therefore, preferably controlled in such a way that the reduction in plasticizer content of the waste PVB is such that the resulting deplasticized recycled PVB satisfies the requirements for the production of a decorative surface covering tile. During the production of the PVB-based thermoplastic material(s) a part of virgin PVB may be added to the deplasticized recycled PVB, but according to preferred embodiments, the totality of the PVB is deplasticized recycled PVB. The PVB of the PVB-based thermoplastic material(s) may, preferably, comprise from 17 wt. % to 23 wt. %, preferably from 18 wt. % to 21 wt. %, still more preferably from 19 wt. % to 21 wt. %, vinyl alcohol (VA). Also preferably, the PVB comprises at most 4 wt. % VAc, preferably at most 2.5 wt. % VAc, more preferably at most 2 wt. % VAc, still more preferably at most 1.5 wt. % VAc and most preferably at most 1 wt. % VAc. The PVB-based thermoplastic material(s) preferably comprises at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

The PVB-based thermoplastic material(s) may contain filler or may be devoid of filler. Filler contents from 10 to 500 wt. % with respect to the PVB content may be chosen. Advantageously, a filler content from 50 to 400 wt. %, preferably from 80 to 300 wt. %, more preferably from 100 to 250 wt. % with respect to the PVB content, may be chosen. Fillers may comprise organic filler material such as, e.g., biochar, ground cork, wood flour, cellulose fibers, bleached chemical wood pulp, etc., and/or mineral filler material such as, e.g., ground limestone, talc, chalk, magnesium carbonate, dolomite, clay, silica, aluminium trihydroxide, pigment(s), etc.

The PVB-based thermoplastic material(s) may further comprise one or more additives, such as, e.g., lubricant(s), stabilizer(s), filler compatibilizer(s). The additives content of the thermoplastic material may be limited to 10 wt. % or less, e.g., to 8 wt. % or less or 7 wt. % or less, with respect to the PVB content.

The step of forming a PVB-based thermoplastic core layer with the deplasticized recycled PVB may comprise an extrusion (or a coextrusion) process.

Examples of PVB-based thermoplastic compositions for flooring panels in accordance with preferred embodiments of the invention are indicated in Table 1 below. The quantities of the ingredients or components are indicated in parts per weight.

TABLE 1

| | Example | | |
|---|---|---|---|
| Ingredient | Ex-A | Ex-B | Ex-C |
| Deplasticized recycled PVB | 100 | 100 | 100 |
| CaCO₃ (filler) | 200 | | |
| Talc (filler) | | 160 | |
| Biochar (filler) | | | 100 |
| Lubricant package | 2 | 4 | 3 |
| Stabilizer package | 0.4 | 0.4 | 0.4 |

In examples Ex-A, Ex-B and Ex-C, deplasticized recycled PVB was obtained by plasticizer extraction from post-consumer PVB flakes purchased from Shark Solutions. Calcium carbonate was Omyacarb 15-VA from Omya, talc was Luzenac ST30 from Imerys, Biochar was purchased from Carbonex. Different lubricant packages were adapted according to the examples and included oxidized PE wax (for example Wiraten XW-12 from Wiwax), stearin (Radiacid 0444 from Oleon) and/or zinc stearate (for example Ligastar Zn 101/6 from Peter Greven) as main components. The stabilizer package includes blends of Irganox (Trademark) 1010 from BASF and Irgafos (Trademark) 168 from BASF. Samples of examples Ex-A, Ex-B and Ex-C were extruded with a twin-screw extruder equipped with a flat die. The melt temperature was close to 180° C.

The (residual) plasticizer content of the compositions according to the examples was 5.2 wt. % w.r.t. to PVB content in Ex-A, 7.8 wt. % w.r.t. to PVB content in Ex-B, and 2 wt. % w.r.t. to PVB content in Ex-C.

Table 2 summarizes a few properties of the PVB-based thermoplastic materials according to the examples.

TABLE 2

| | Ex-A | Ex-B | Ex-C |
|---|---|---|---|
| Residual plasticizer content (wt. % w.r.t. to PVB | 5.2 | 7.8 | 2 |
| content) | | | |
| Coefficient of Linear Thermal Expansion (10⁻⁵/° C.) | 9 | 4.5 | 9.5 |
| Stress at break (MPa) | 42 | 75 | 49 |
| Flexural modulus (GPa) | 6.2 | 8.7 | 3.6 |
| Glass transition temperature (° C.) | 68 | 61 | 74 |

The flexural modulus was determined each time from the slope of a stress-strain curve produced by a flexural test (3-point bending test) measured on a 50 mm wide×80 mm long sample (the length extension corresponding to the machine direction). The load was displaced at a rate of 4%/min until break. The flexural modulus was determined as the initial slope of the of the stress-strain curve. The stress at break indicated in Table 2 corresponds to the respective maximum recorded stress.

As indicated in Table 2, it was found that stiff PVB-based thermoplastic materials exhibit good thermomechanical properties (stress at break, low thermal dilatation, good planar stability . . . ) and are thus suitable for use in core layers of rigid LVTs with locking connectors. It may be worthwhile noting that surface coverings according to the invention may have a stiffness that is unachievable with conventional plasticized PVB, in particular with waste PVB that has not undergone extraction of plasticizer.

Flooring assembled from flooring tiles according to the invention including the PVB-based compositions according to examples Ex-A, Ex-B and Ex-C were subjected to the Castor chair test as specified in standard ISO 4918:2016. The flooring tiles comprised locking connectors along their edges. After 25000 cycles, no damage was noted on the flooring surface and the locking connectors.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A method of processing PVB, the method comprising: extracting plasticizer from solid post-consumer or post-industrial PVB, wherein the extraction is carried out with supercritical carbon dioxide.

2. The method as claimed in claim 1, wherein the extraction is carried out with supercritical carbon dioxide at a pressure in the range from 80 to 500 bar and at a temperature in the range from 33° C. to 70° C.

3. The method as claimed in claim 1, wherein the PVB is in the form of flakes that have an average thickness from 100 μm to 1.6 mm.

4. The method as claimed in claim 1, wherein the PVB is in the form of flakes that have an average diameter from 1 mm to 30 mm.

5. The method as claimed in claim 1 wherein the PVB is in the form of powder.

6. The method as claimed in claim 1, wherein the extraction is conducted with a solvent-to-feed mass ratio of at least 10.

7. The method as claimed in claim 1, wherein the post-consumer or post-industrial PVB has a plasticizer content of at least 23% by weight.

8. The method as claimed in claim 1, wherein the post-consumer or post-industrial PVB has a content in residual glass particles of less than 2% by weight.

9. The method as claimed in claim 1, wherein, after the extraction of plasticizer, the PVB has a residual plasticizer content of at most 20% by weight.

10. The method as claimed in claim 1, wherein, after the extraction of plasticizer, the PVB has a residual plasticizer content of at most 50%.

11. The method as claimed in claim 1, wherein supercritical carbon dioxide carrying plasticizer extracted from the PVB is expanded to release plasticizer and recirculated at least in part.

12. The method as claimed in claim 1, wherein the extraction is carried out with supercritical carbon dioxide without any further cosolvent.

13. The method as claimed in claim 1, wherein the extraction is carried out with supercritical carbon dioxide with one or more cosolvents, e.g., one or more cosolvents selected from methanol, ethanol, propanol, butanol, and acetone.

14. The method as claimed in claim 13, wherein the mass ratio of the cosolvent to the supercritical carbon dioxide does not exceed 15%.

15. The method as claimed in claim 1, wherein the extraction is carried out with supercritical carbon dioxide at a pressure in the range from 80 to 500 bar, and at a temperature in the range from 33° C. to 70° C.; wherein the PVB is in the form of flakes that have an average thickness from 100 μm to 1.6 mm and an average diameter from 1 mm to 30 mm; wherein the extraction is conducted with a solvent-to-feed mass ratio of at least 10; wherein the post-consumer or post-industrial PVB has a plasticizer content of at least 23% by weight; wherein the post-consumer or post-industrial PVB has a content in residual glass particles of less than 2% by weight; wherein, after the extraction of plasticizer, the PVB has a residual plasticizer content of at most 20% by weight and of at most 50% of the initial plasticizer content; and wherein supercritical carbon dioxide carrying plasticizer extracted from the PVB is expanded to release plasticizer and recirculated at least in part.

16. (canceled)

17. (canceled)

18. (canceled)

19. The method as claimed in claim 1, wherein, after the extraction of plasticizer, the pressure vessel containing the PVB is decompressed to an intermediate pressure range in which a filler fluid is supplied to the pressure vessel so as to replace part of the carbon dioxide contained therein and the pressure vessel containing the PVB is then decompressed to a final pressure.

20. The method as claimed in claim 1 wherein, after the extraction of plasticizer, the pressure vessel containing the PVB is decompressed in two successive steps:
1) a step of fast decompression at a decompression rate which is in the range from 5 bar/min to 30 bar/min, until the pressure within the pressure vessel is in the range from 20 to 50 bar, and
2) a step of slow decompression at a decompression rate which is in the range from 0.05 bar/min to 4 bar/min until the pressure within the pressure vessel is the atmospheric pressure.

21. The method as claimed claim wherein the extraction is carried out in a pressure vessel which is a wall-heated fixed bed reactor.

22. (canceled)

23. A method for producing a decorative surface covering, the method comprising: sourcing PVB using the method as claimed in claim 1, forming a PVB-based thermoplastic core layer with the PVB, covering the PVB-based thermoplastic core layer with a wear layer, arranging a décor layer between the PVB-based thermoplastic core layer and the wear layer, and, optionally, backing the PVB-based thermoplastic core layer with a backing layer.

24. (canceled)

25. (canceled)
